(19) United States
(12) Patent Application Publication
(10) Pub. No.: US 2019/0240917 A1
(43) Pub. Date: Aug. 8, 2019

(54) METHOD OF ACTIVATING ADHESIVES

(71) Applicant: MultiMaterial-Welding AG, Stansstad (CH)

(72) Inventors: Jörg Mayer, Niederlenz (CH); Martin Rhème, Befloux (CH)

(21) Appl. No.: 16/339,492

(22) PCT Filed: Oct. 6, 2017
(86) PCT No.: PCT/EP2017/075538

§ 371 Date: Apr. 4, 2019

(30) Foreign Application Priority Data
Oct. 7, 2016 (CH) 01346/16
Dec. 7, 2016 (CH) 01612/16

(51) Int. Cl. B29C 65/08; B29C 65/48; B29C 65/50

(52) U.S. Cl. CPC B29C 65/081; B29C 65/485; B29C 65/7826; B29C 65/5057; B29C 65/4875

(57) ABSTRACT

A method of fastening a second object to a first object includes: providing the first object with an attachment surface; providing the second object; placing the second object relative to the first object, with a resin composition in between the attachment surface and the second object, wherein the resin composition has a resin having a first viscosity and being in a flowable state; pressing the first and second objects against each other and causing mechanical vibration to act on at least one of the objects until the resin composition experiences a vibration induced activation, which includes at least one of reduction of the viscosity of the resin compared to the first viscosity and activation of particles dispersed in the resin. The pressing and mechanical vibration are continued or repeated until the resin has at least partially cross-linked and the viscosity of the resin is increased compared to the first viscosity.

### FIELD OF THE INVENTION

The invention is in the fields of mechanical engineering and construction, especially mechanical construction, for example automotive engineering, aircraft construction, shipbuilding, machine construction, toy construction etc. It more particularly relates to manufacturing articles including a step of fastening objects to each other as well as to adhesive compositions for such manufacturing methods.

### BACKGROUND OF THE INVENTION

In the automotive, aviation and other industries, there has been a tendency to move away from steel constructions and to use lightweight material such as fiber composites, especially carbon fiber reinforced polymers or glass fiber reinforced polymers, instead.

While fiber composite parts may, given a sufficiently high fiber content and average fiber length and given an appropriate fiber orientation, be manufactured to have considerable mechanical strength, the mechanical fastening of a further object, such as a connector (dowel or similar) thereto is a challenge. Conventional riveting techniques are suitable only to a limited extent, especially due to the small ductility of the fiber composite materials. Also, since such connections require pre-drilling at the position where the further object is to be attached, precision of the positioning may be an issue, especially if several parts that are connected to each other are to be attached to the fiber composite part. A further disadvantage is that pre-drilling weakens the object to which the connector (or similar) is fastened. Adhesive connections may work well but suffer from the drawback that the strength of a bond cannot be larger than the strength of an outermost layer and of its attachment to the rest of the part. Further, curable (thermosetting) adhesives always require a certain curing time for cross-linking. This will considerably increase the production time in case of industrial production. In order to solve this problem, it has been proposed to use UV curable adhesives that tend to cure faster than thermally curing adhesives. However, they require at least partially transparent connectors to allow the curing radiation to reach the curable adhesive. In addition, glue lines depending on the set-up may suffer from sensitivity in terms of layer thickness and homogeneity of glue distribution.

Similar challenges exist for adhesive connections to other materials.

WO 97/25360 discloses adhesives compositions on a polyurethane prepolymer basis for bonding glasses to other substrates, such as metal or plastics, for example for bonding a glass window to a window frame of an automobile. The compositions may comprise encapsulated curing agents, of which the particles are ruptured, especially by the application of heat, shear forces, ultrasonic waves or microwaves or by the composition being forced through a screen that at its smallest point is smaller than the particle size. Also WO 2008/094368 discloses rupturing encapsulations with a curing agent by applying ultrasonic energy for the purpose of adhering a glass panel to components of a vehicle. These teachings while trying to solve specific problems in car manufacturing do not address the above-mentioned challenges in a general manner.

It would therefore be advantageous to provide a method of fastening a further, second object (for example a connector) to a first object, which overcomes drawbacks of prior art method and which especially yields a strong reliable mechanical bond. It is a further object to provide compositions suitable for this purpose.

### SUMMARY OF THE INVENTION

According to an aspect of the invention, a method of fastening a second object to a first object is provided, the method comprising:
Providing the first object comprising a first attachment surface;
Providing the second object;
Placing the second object relative to the first object, with a resin composition in between the first attachment surface and (a second attachment surface of) the second object, wherein the resin composition comprises a resin, the resin composition having a first viscosity;
Pressing the second object and the first object against each other and causing mechanical vibration to act on the second object or the first object or both, until the resin composition is subject to a vibration induced activation,
Wherein the activation comprises at least one of reduction of the viscosity of the resin composition compared to the first viscosity, and of an activation of at least one element at least partially environed by the resin, for example particles dispersed in the resin,
Continuing or repeating the step of pressing and causing mechanical vibration to act until the resin has at least partially cross-linked and the viscosity of the resin is increased (at least locally) compared to the first viscosity,
Whereby the resin composition secures the second object to the first object.

In this text, “resin” denotes any substance that is flowable (generally a viscous liquid) and is capable of hardening permanently by covalent bonds generated between molecules of the resin and/or between molecules of the resin and other substances. For example, the resin may be a composition comprising a monomer or a plurality of monomers or a prepolymer in a flowable state that is capable of changing irreversibly into a polymer network by curing.

The activation step by reducing the viscosity and/or releasing a substance may comprise removing or lowering a barrier to intra-composition mobility. In embodiments with a plurality of the elements dispersed in the resin, the elements need not necessarily be solid but may for example be dispersed in the resin meta-stably, so that they form an emulsion together with the resin. Activation by the mechanical vibration may then comprise causing a local micro-circulation to promote mixing and thereby to significantly enhance the reaction surface between the phases (between the elements and the resin) to trigger a reaction.

It has been found by the inventors that the mechanical vibration may be caused to take effect in three possible ways: Firstly, it may result in an increased mobility within the resin composition, for the resin itself, by the viscosity of the resin being reduced and/or for an other substance of the composition, for example in some embodiments by the substance being initially contained in the particles and being released. In addition, in embodiments the vibration may cause the resin to become well distributed and to completely wet/interpenetrate and if applicable embed any structure on the attachment surface (the first attachment surface or a second attachment surface of the second object) thereby cause the resin to penetrate into such structure relatively deeply.

Secondly, the mechanical vibration energy is primarily absorbed at the interface between the first object and the second object and in the resin, thereby stimulating the curing process. More precisely, the resin has to be found to cure rather efficiently and predominantly at the interface. Thus, the vibration will then cause an increase in viscosity and a rapid hardening.

Thirdly, the mechanical vibration causes the activation. As explained in more detail hereinafter, if the activation comprises an activation of the particles, this may take effect in different ways.

If the attachment surface is provided with an according structure, after the hardening process, the resin in addition to causing a material connection (i.e. an adhesive bond) may also cause a positive-fit connection due to the fact that it has interpenetrated the structure, which structure may include undercuts.

In practice, it has been found (for example using a commercially available two-component epoxy adhesive as the resin) that the curing process is accelerated compared to how quick it would have been without the ultrasonic vibration by at least an order of magnitude. As a role of thumb, a temperature increase of about 10° C. reduces the setting time by 50%. In practice, a short term (for example 2-3 s), ultrasound induced temperature increase of about 50° C. or even 100° C. may be observed.

The resin composition may be composed to be capable of being subject to a vibration induced activation.

A first group of embodiments concerns a resin composition the viscosity of which may be reduced by vibration before the cross-liking process raises the viscosity again.

In embodiments of this first group, the resin composition initially, during the step of placing, has a rather high viscosity, even to an extent that it is perceived to be almost solid and essentially not sticky. Then, in the step of providing, the first and/or second object may be provided with the resin as pre-applied coating. It is for example possible that a plurality of first and/or second objects are stored with the resin coating already applied.

For example, in a sub-group of the first group, the resin may be pre-polymerized prior to the step of placing the second object relative to the first object, i.e. pre-polymerized prior to being applied. The pre-polymer may have a liquefaction temperature (melting temperature or other temperature at which it becomes sufficiently flowable) that is above the temperature at which the objects are initially provided (room temperature for most applications).

In a further sub-group of the first group, the resin composition comprises an additive that has a stabilizing effect. An example of such a stabilizing additive is bentonite. Bentonite is, according to the prior art, known for paints that do not drip and that become sufficiently flowable only when under mechanical stress (thixotropy effect). The viscosity thus is decreased as soon as, by the mechanical vibration, the shear rate goes up.

In an even further sub-group the composition has an additive that reduces the viscosity because it has a low glass transition and/or liquefaction temperature.

In embodiments, including embodiments of the mentioned sub-groups, the resin composition may be thixotropic.

Resin compositions that have the property of being relatively solid at room temperature and that may be hardened by being heated are known in the art.

The present invention according to the first group of embodiments adds the following function
In contrast to prior art processes that involve heating, the heating is not done by heat conduction from a remote heat source via a thereby heated surface into the resin composition, but by mechanical vibration energy absorption. This vibration energy absorption takes place primarily at the interface to the object to which the bonding is to take place (external friction; the heat generated on both sides of the interface) and within the resin composition itself (internal friction). Thus the approach according to the invention makes a targeted heating and hence contribution to the activation possible. This first function is independent of whether the embodiment belongs to the first group or not.
Further, the mechanical vibration energy brings about a high internal shear rate and thus makes use of thixotropy effects taking place in the resin composition. Thereby, an additional contribution to the temporary reduction of the viscosity and thereby to the activation is made.

Due to the increased mobility within the activated resin composition, the cross-linking process is stimulated to a large extent.

In special embodiments of the first group, the composition comprises abrasive particles.

In a second group of embodiments, the resin composition is composed to be activatable by mechanical vibration by the fact that it comprises at least one element, for example particles, capable of being activated.

Generally, it is possible to combine properties of the first group with properties of the second group, i.e. embodiments may belong to both groups by being capable of reducing the viscosity upon activation and by additionally comprising an activatable element, for example particles.

Such activatable particles may comprise polymer particles, especially thermoplastic particles. Upon absorption of vibration energy, these particles are heated by internal and/or external friction. Thereby, they transfer energy to the surrounding material. Similar considerations apply for auxiliary elements that do not necessarily need to qualify as particles, for example a distance holding spacer of thermoplastic material.

In a sub-group of embodiments, the element is/the particles are of a material that remains essentially solid during the process, i.e. the optimal cross-linking temperature of the resin is well below the temperature at which the element/particle material becomes flowable. However, the optimal cross-linking temperature may be around the glass transition temperature of the material or slightly above this glass transition temperature, because vibration energy absorption—and hence heat dissipation to the resin—becomes higher as soon as the glass transition temperature is reached.

A typical candidate for a material for an element/for particles of this sub-group comprises a cross-linked elastomer. Above the glass transition temperature, such material absorbs the vibration energy by transforming it into heat that further enhances the internal heating process of the resin. Typical candidates are Butylene Rubber, or Polyurethane, as for example described in P. H. Mott et al, J. Acoust. Soc. Am. 111 (4), April 2002, P. 1782-1790.

In a further sub-group of embodiments, the activation of activatable particles (or an other auxiliary element), especially thermoplastic particles, is used for controlling the temperature of the resin and/or heat dissipation to the resin.

Especially, in embodiments of this sub-group, the element/particles may comprise a substance capable of undergoing a first order phase transition (a phase transition involving a latent heat). The phase transition temperature of such substance may especially be chosen to be below the critical temperature (overheating temperature) of the resin but sufficiently high for the curing process to be substantially stimulated.

It has been found that, depending on the set-up, the resin composition sometimes is primarily heated at the interface to the second object and/or to the first object, especially at the more proximal of these interfaces (the interface between the one object into which mechanical vibration is coupled and the resin composition). This may be due to interface effects and/or to a heating of the respective more proximal object itself by the mechanical activation. The effect may cause local overheating of the resin composition and/or insufficient activation/curing at other places than the one interface, for example at the other interface and/or in an interior.

In accordance with embodiment of this sub-group, the substance capable of a first order phase transition is a thermoplastic material. Other substances capable of undergoing a first-order phase transition (thus having a latent heat) or other substances having a high heat capacity would be suitable as well.

In embodiments of this sub-group or generally in embodiments of the second group, therefore, thermoplastic particles are dispersed in the resin. Especially, the thermoplastic particles may be of the kind that may be subject a phase transition, especially a first-order phase transition (melting-crystallization of at least some zones for example), at a temperature below the overheating temperature of the resin but sufficiently high for the curing process to be substantially stimulated. Especially, such phase transition temperature may be in the region of the optimal cross-linking temperature of the resin, which is a temperature above a threshold temperature for the cross linking to start if such threshold temperature is defined. Such optimal cross-linking temperature is derivable from the specification of the resin and is a material property.

A filler having a first-order phase transition brings about the effect that an overheating of the resin is prevented in that the particles absorb heat as soon as the first order phase transition temperature is reached and as long as not all material of the filler has undergone the phase transition. Thereby, the temperature is stabilized. Further, after the energy input by the mechanical vibration stops, the resin cools down only slightly, and then heat dissipation from the filler into the resin sets in, whereby a further cooling down is stopped or at least substantially delayed. Often, the melting temperature is somewhat higher than the crystallization temperature (hysteresis behavior), depending on the cooling velocity and the nucleation of the polymers. Thereby, the time duration of the required vibration input is reduced compared to the time it takes for the resin to sufficiently cross link when it is at the optimal cross-linking temperature.

Especially if the filler comprises thermoplastic particles, the particles may have one or more (for example all) of the following properties.
The material of the particles is such that it has a first-order phase transition, with a phase transition temperature below the critical overheating temperature of the resin. Especially, the phase transition temperature is in the region of the optimal cross-linking temperature of the resin.
   The material of the particles may be such that the phase transition is quick so that heat can be absorbed and released quickly.
   Examples of a suitable material are the polyamides PA11 or PA12. These polyamides exhibit a melting temperature Tₘ of about 178° C., re-crystallize upon cooling to about 155° C. (depending on circumstances) and have a rather quick crystallization kinetics. They, therefore, are especially suitable for resin systems that harden at typically between 150° C. and 170° C.—such as epoxy based resins typically used in some industries, such as the car manufacturing industry.
The particles have an at least approximately spherical geometry. Thereby, an optimized degree of filling is achievable while the influence on (initial) viscosity is minimized.
The particles size (average diameter) is between 10 μm and 100 μm, thus, the particles are a powder dispersed in the resin matrix.
The particles have a similar elastic modulus (Young's modulus) as the resin after the latter has hardened, for example by differing by at most a factor 3 or at most a factor 2. Thereby, mechanical loads on the connection between the first and second objects are equally distributed within the composition, and no specific distortions arise.
At least the surface of the particles is capable of reacting chemically with the resin. If necessary, this may be brought about by a surface treatment with a linker to the resin (including, if present, hardener etc.).
   The capability of the surface to react with the resin is advantageous if the development of cracks within the hardened resin is an issue.

Chemical bonds between the resin and the particle surface prevent cracks from progressing along the surfaces of the particles.

An example of a substance that is suitable as filler of a resin is emulsion polymerization powder of PA11 or PA12, with the powder particle surfaces being surface treated (for example silanized) by a linker for the particular resin/hardener system.

Alternative suitable fillers capable of undergoing a first-order phase transition are particles of phase change materials (PCMs), including materials with a solid-solid phase transition, for example X180 of PCM product limited.

More generally, fillers of a material capable of undergoing a first-order phase transition may be capable of undergoing any first-order phase transition. i.e. a phase transition that involves latent heat, including but not limited to solid-liquid and solid-solid first order phase transitions.

In addition or as an alternative, a filler of elements that homogenize the temperature distribution across the resin are particles of highly efficient heat conducting material such as copper, aluminum, carbon based materials (graphite, fullerenes, nanotubes, etc.), heat conducting ceramics such as silicon carbide, etc.

An interesting category of materials suitable as material of filler particles are materials that have a high internal friction so that they generate heat when they are mechanically loaded. This is especially the case for visco-elastic material that forms a hysteresis during a loading-unloading cycle. This damping capability is expressed by the loss tangent (tan δ) properties of the visco-elastic material. A particularly interesting group of materials are PTFE based materials, since they combine a high internal friction with a good heat conducting capability (i.e. in addition to heating themselves they contribute to a good heat distribution). An other group are elastomeric materials, also if they are not thermoplastic.

Activatable particles of the hereinbefore discussed kind, especially if they do not, or at least not entirely, liquefy, may, in addition to serving for activating the resin by exchanging heat with the resin, also serve as distance holders between the first and second object when the first and second objects are pressed against each other for being connected, with the resin composition between them. This is for example especially the kind for the hereinbefore discussed elastomer particles. The distance holder effect may be advantageous for maintaining a certain minimum height of the adhesive gap between the objects fastened to each other.

The above teaching as far as relating to activatable thermoplastic particles also applies to auxiliary thermoplastic elements that do not necessarily qualify a particles. For example, such element may have a dimension sufficiently large to be in contact with both, the first and second attachment surfaces (with in each case a possible thin resin layer in-between). Thereby, it may have at least one of the functions heating element for the cross linking activation (as discussed hereinbefore); distance holder between the first and second objects; mechanical stabilizer of the connection between the first and second objects, especially together with the measure of an attachment surface with an attachment structure defining an undercut, as discussed hereinafter.

In a group of embodiments, the first attachment surface and/or the second attachment surface comprises/comprise an attachment structure. Such attachment structure may comprise an arrangement of protrusions and/or indentations.

It may firstly serve for stabilization: Firstly, it is after the process penetrated by material of the resin composition, i.e. by the hardened resin or by re-solidified thermoplastic material of the element (such as the dispersed particles or (other) auxiliary element). Thereby, it adds stability to the effect of the adhesive. This is especially the case if the attachment structure comprises undercut protrusions and/or indentations whereby the first and/or second object is secured by a positive-fit connection.

Secondly, the attachment structure may have structures that serve as energy directors when they are in physical contact with thermoplastic material of the element(s) when the mechanical vibration impinges.

Attachment structures may also comprise a high surface roughness, for example by sandblasting using sharp grains, with a roughness (Rₐ) of for example more than 50 or 100 micrometers.

In connection with resin material that hardens comparably slowly (for example polyurethane), the stabilization effect may be used for a temporal stabilization: if the thermoplastic element(s) is/are is sufficiently large bridge the gap between the first and second objects (for example if they serve as distance holders), then the thermoplastic material after having flown relative to the attachment structures and after re-solidification serves the first and second objects relative to each other by a positive-fit connection. This allows the arrangement of the first and second objects to be removed from the processing station where they are secured to each other and to be further processed while the resin hardens.

Especially in embodiments in which the element(s) environed by the resin is/are thermoplastic, it may be advantageous to choose an elastic modulus (Young's modulus) that is similar to the elastic modulus of the resin once the resin has fully hardened. For example, the elastic modulus of the thermoplastic at room temperature may be not less than 30% below and not less than 50% above the elastic modulus of the hardened resin. The elastic modulus of thermoplastic materials is a well-known quantity known from data sheets etc., and the skilled person may choose between similar materials having different elastic moduli. If the elastic moduli of the resin and of the thermoplastic material are adapted to each other, hard spots in the joint may be avoided, and this may be beneficial for long-term stability.

In an other embodiment, the activatable particles comprise particles that when being mechanically loaded form a self-stabilizing particle network (especially a so-called “percolating network”) that is capable of transferring mechanical vibration.

Activation may comprise causing friction between the particles of the particle network, whereby heat is generated and transferred to surrounding resin.

Particles suitable for this purpose may comprise ceramic or glass particles.

Such self-stabilizing network also has the possible effect of being a distance holder, thereby defining the thickness of the adhesive (resin) layer.

In addition or as an alternative, such particles may comprise an activation component, for example at least one of:
A hardener/curing agent (for example water; especially in case of poly addition reaction);
An initiator substance, for example a radical generator for resins subject to free radical polymerization/free radical cross linking.
Gas forming substance, such as substances that release carbon dioxide or water upon activation, for example due to thermal effects.

The activation component may be contained in vesicles that comprise the activation component in a membrane that is being broken (destroyed/ruptured) due to effects that are present when mechanical vibration impinges, for example high shear rates, pressure pulses, cavitation effects or thermal effects.

In addition or as an alternative, the activation component may be present as particles, for example droplets, dispensed in the resin. Especially, the manufacturing of the resin composition may comprise generating a metastable segregation between the resin on the one hand and the activation component on the other hand. Activation by the mechanical vibration will cause the energy barrier for mixing to be overcome and will thus cause an at least partial dissolution of the activation component in the resin. Similarly, the activation component may be present in the form of particles the viscosity of which is too high for mixing prior to activation but in which the activation by the mechanical vibration reduces the viscosity (due to heating and/or thixotropy effects) so that subsequently the activation causes a homogenization.

In these embodiments, as well as in embodiments that comprise heating up the particle—directly or indirectly by absorbing energy from the resin—and embodiments that comprise moving the particles between each other, the activation concerns the entire particles, i.e. the bulk of the particle material. This is in contrast to the embodiments in which activation merely comprises releasing an activation component by a membrane being ruptured, where the activation merely concerns the particle surface/the membrane.

The term “particles” as used in this text also includes metastable droplets and separated other (second) phases of a material.

An advantage of providing a substance in small particles (vesicles or particles directly dispensed in the resin) within the composition is that the diffusion paths are much shorter than if the substance is only present at a surface of the resin. A further advantage is that activation is possible also of resin compositions that are difficult to activate by thermal effects, such as polyurethane pre-polymers.

In a further group of embodiments, the particles comprise a substance that takes effect by being released from a surface of the resin composition.
In an embodiment, a substance of the particles (contained in the vesicles or present for example as droplets dispensed in the resin) comprises a solvent that has a cleaning effect on the attachment surface of the first and/or second object. Hence in situations where a separate cleaning step of the surface would be difficult to achieve or has other disadvantages, the cleaning step may be combined with the fastening step due to the approach according to the invention. This is especially beneficial in view of the mobility stimulating effect the approach according to the invention has.
In an other embodiment, a substance of the particles comprises an etchant or other substance that physically (for example by inducing roughness) and/or chemically prepares the first and/or second attachment surface.
In an even further embodiment, a substance of the particles comprises a primer (bonding agent) cooperating both, with the first/second attachment surface and with the resin contained in the resin composition.

It has been described in this text that particles capable of absorbing heat, especially particles comprising a substance capable of a first-order phase transition, are suitable for stabilizing the temperature and thereby causing the temperature distribution across the resin to be homogeneous. Other measures to this effect are possible in addition or as an alternative:

In many embodiments, for example, for the process that comprises the mechanical vibration to act on the second and/or first object, one of the objects (the distal object) is held against on a non-vibrating support, while the other one of the objects (the proximal object) is pressed against the distal object by a vibrating tool, with the resin composition between the objects. For a homogeneous temperature distribution, the non-vibrating support may be configured not to absorb too much heat.
In accordance with a first possibility, the non-vibrating support may be, at least at the interface to the distal object, of a material that is a bad heat conductor but that is comparably temperature resistant, such as wood, a wood-based composite material, silicone, a heat-resistant plastic, etc.
In accordance with a second possibility, that may be combined with the first possibility, the non-vibrating support and the distal object are shaped so that no direct physical contact between them exists immediately distally of the spot where the vibration impinges.
In accordance with a further possibility, which may be combined with the first and/or second possibility, the coupling of the vibration energy into the object is adapted by a coupling element being placed between the vibrating tool and the object. Such coupling element may for example be a polymer foil, such as a PTFE foil between the sonotrode and the object. Such coupling element may comprise one or more of the following functions:
   Vibration absorption (noise reduction) and mechanical protection of the surface, by avoiding hard-hard conflicts.
   Improvement of the vibration transfer, because the different resonant frequencies between the vibrating tool and the object may be compensated by the coupling element, whereby the efficiency of the vibration transfer is improved.
   Generation of additional heat (especially if having visco-elastic and/or elastomeric properties, as is the case for PTFE, see the teaching above) and/or reduction of the heat flow away from the object. This may especially be helpful with objects, such as sheet metal objects, that are particularly thin and/or have a high heat conductivity such as Aluminum.

In embodiments, the vibration power coupled into the assembly of the first and second objects with the resin composition between them follows a time dependent profile. To this end, for example the vibration amplitude may be accordingly modulated while the frequency remains constant; vibration frequency modulation is not excluded though. Especially, the vibration power input may be smaller in an initial phase so that wetting of the first/second object by the resin is supported and/or the viscosity is caused to be reduced, while there is no substantial cross-linking. In this first phase, the pressing force may be comparably high to support the wetting process. Then, in a second phase, the vibration power may be higher to initiate the cross-linking and, if applicable, to activate the particles, for example to release a substance, to melt, etc. During this second phase, in some embodiments the pressing force may be reduced to make a relatively free vibration possible. In an optional third phase, the vibration may be switched off while a pressing force, for example an increased pressing force, is maintained.

In other embodiments in which the vibration power follows a time dependent profile, the vibration may be repeatedly switched on and off, with for example on and off times of a few seconds each (such as 1-3 s) for example combined with a longer holding phase after the last vibration input. In an example, the on and off times are 2 s each, with 3 on-off-cycles, and with a holding time that is long enough for the total process to take place 3 minutes.

In embodiments, the first object comprises a fiber composite part comprising a structure of fibers embedded in a matrix material. In a group of embodiments, the fiber composite part will especially comprise a portion of the structure of fibers being exposed at the first attachment surface. Flowable resin material then is caused to interpenetrate the structure of fibers, possible voids in the material are caused to evade. The vibrations may also cause small motions of the fibers themselves, and this helps to prevent spots from not being impregnated at all. An exposed structure of fibers will naturally comprise structures that define an undercut, whereby the above-mentioned positive-fit connection is achieved without any additional measures being required.

In particular, the method may comprise the step of causing the portion of the structure of fibers to become exposed, especially by removing an outermost portion of the matrix.

The resin used in these embodiments may be of a same chemical composition as the matrix material of the fiber composite part, or it may be of a different composition.

In other embodiments, the first object has a surface of any other material, including a metal or a ceramic material, in both cases with or without added surface roughness.

A tool by which the vibration is applied may be a sonotrode coupled to a device for generating the vibration. Such a device may for example be a hand-held electrically powered device comprising appropriate means, such as a piezoelectric transducer, to generate the vibrations.

The mechanical vibration may be longitudinal vibration; the tool by which the vibration is applied may vibrate essentially perpendicular to the surface portion (and the tool is also pressed into the longitudinal direction); this does not exclude lateral forces in the tool, for example for moving the tool over the surface portion.

In other embodiments, the vibration is transverse vibration, i.e. oscillation predominantly at an angle, for example perpendicular, to the proximodistal axis and hence for example parallel to the first and second attachment surfaces. Vibration energy and amplitude in this may be similar to parameters of longitudinal vibration.

In a further group of embodiments, which may be viewed as a sub-group of embodiments with transverse vibration, the oscillation may be rotational oscillation, i.e. the vibrating item vibrates in a back and forth twisting movement.

The mechanical vibration may be ultrasonic vibration, for example vibration of a frequency between 15 KHz and 200 kHz, especially between 20 KHz and 60 kHz. For typical sizes of second objects (for example with characteristic lateral dimensions of about 1 cm) and dimensions of composite parts for example for the automotive industry (car body parts), a power of around 100-200 W has turned out to be sufficient, although the power to be applied may vary strongly depending on the application.

In any embodiment, there exists the option of carrying out the method by a tool that comprises an automatic control of the pressing force. For example, the device may be configured to switch the vibrations on only if a certain minimal pressing force is applied, and/or to switch the vibrations off as soon as a certain maximum pressing force is achieved. Especially the latter may be beneficial for parts of which an undesired deformation must be avoided, such as certain car body parts.

To this end, according to a first option the capability of piezoelectric transducers to measure an applied pressure may be used. According to a second option, a special mechanism can be present in the device. For example, a unit that contains the transducer and to which the tool (sonotrode) is attached may be mounted slideable against a spring force within a casing. The device may be configured so that the vibrations can be switched on only if the unit is displaced by a certain minimal displacement and/or only if it is not displaced by more than a certain maximum displacement. To achieve this, means well-known in the art such as light barriers, sliding electrical contacts, position sensitive switches or other means may be used. Also a collapsible sleeve or similar of the kind described hereinafter may contain or operate a contact or switch or similar to control the pressing force.

The vibration frequency can influence the manner in which the vibrations act. A lower frequency will lead to a longer wavelength. By adapting the wavelength to the dimensions of the part to be completed, the operator can have an influence on in which depth the effect of the vibrations is the strongest and on whether the energy is primarily absorbed in a ‘near field’ regime, in a ‘far field’ regime or in an intermediate regime.

### BRIEF DESCRIPTION OF THE DRAWINGS

In the following, ways to carry out the invention and embodiments are described referring to drawings. The drawings are schematical. In the drawings, same reference numerals refer to same or analogous elements. The drawings show:

FIG. 1, in section, an arrangement of a first object, a second object and a sonotrode;

FIG. 2 a development of the viscosity during the process according to an embodiment;

FIG. 3 a development of the diffusion during the process according to an embodiment;

FIG. 4 a resin composition with vesicles;

FIGS. 5 and 6 a resin composition with abrasive particles during two different stages of a process;

FIG. 7 an arrangement of relatively large first and second objects;

FIG. 8 a further arrangement of a first object, a second object and a sonotrode;

FIGS. 9-11 further resin compositions;

FIG. 12 a further arrangement of a first object, a second object, and a resin composition portion;

FIG. 13 a temperature-vs.-time diagram;

FIG. 14 a process diagram;

FIGS. 15 and 16 sections through an assembly of a first object, a second object and a sonotrode, with a resin bead being dispensed between the first and second objects;

FIG. 17 an example of a second object;

FIG. 18 a section through an arrangement with a structured particle serving as an auxiliary element;

FIGS. 19-21 top views of embodiments of structured particles;

FIG. 22 a structured particle with a guiding nipple;

FIGS. 23-25 sections illustrating measures for confining the resin composition;

FIGS. 26 and 27 sections through arrangements with an attachment structure;

FIG. 28 a section through an auxiliary element; and

FIGS. 29 and 30 alternative attachment structures.

### DESCRIPTION OF THE PREFERRED EMBODIMENTS

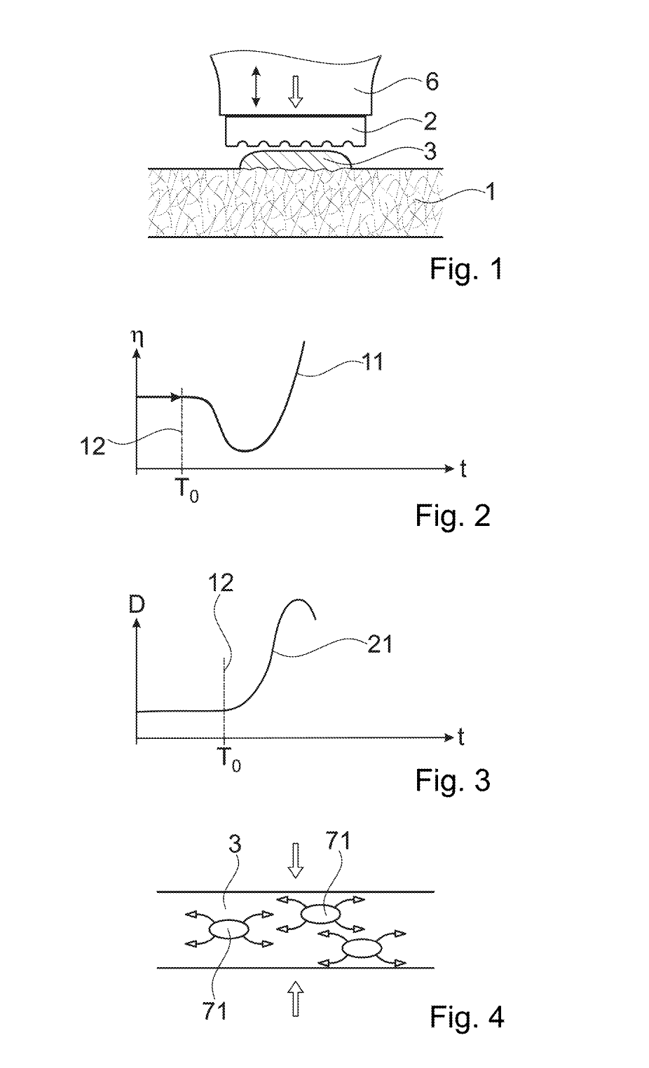

FIG. 1 shows, in section, an arrangement of a first object 1, and a second object 2, with a resin composition portion 3 therebetween. The first object in the depicted embodiment is a fiber composite part 1 hat has a structure of fibers embedded in a matrix of hardened resin. The structure of fibers is locally exposed at a first attachment surface portion of the surface of the first object, for example by matrix material being removed. The resin composition portion 3 is applied to the exposed part of the surface.

In the depicted embodiment, the first object comprises a fiber composite material at least at the first attachment surface. However, other surfaces with suitable physical (roughness, porosity) and/or chemical properties are suitable as well. Especially, suitable first object and/or second materials include metals, ceramic materials, wood or wood-based material, other plastic materials than fiber composites, etc., all with or without surface roughening.

For illustration purposes, in all depicted examples, the first object is shown to have a general flattish shape. All examples of the invention are, however, also applicable to first objects that are not flattish but have any other shape.

Also the second object may have any shape, as long as a common attachment interface comprising a first attachment surface and a second attachment surface is formed. Especially, in embodiments the second object may be a connector comprising a fastening structure for fastening a further object to the second object and thereby to the first object.

The second object may have any material suitable for the specific purpose of the second object and further for an adhesive connection with the first object via the resin. For example, the second object may comprise at least on of a metal, a ceramic, a polymer based material, for example a composite, etc. Especially, in embodiments the second object may comprise a fiber reinforced composite, especially with fiber exposed at the second attachment surface. Other surfaces with suitable physical (roughness, porosity) and/or chemical properties are suitable as well.

The second object is illustrated to have a distinct structure on a distal side thereof for example a plurality of indentations, for example channels. The distal surface of the second object forms a second attachment surface of the configuration.

The second object may for example be a fastener for fastening a further object to the first object.

For fastening the second object and the first object to each other, a sonotrode 6 is used to press the second object against the first object, with the resin composition portion 3 between the parts, while mechanical vibration is coupled via the sonotrode into the second object 2. It has been found that the mechanical vibration has a double effect: Firstly it causes the resin to become well distributed and to completely wet/interpenetrate and if applicable embed any structure on the attachment surfaces, thereby cause the resin to penetrate into such structure relatively deeply. Secondly, the mechanical vibration energy is primarily absorbed at the interface between the first object and the second object and in the resin, thereby stimulating the curing process.

In FIG. 1, the resin composition 3 is illustrated to be disposed as a portion applied to the first attachment surface, for example by an according dispensing tool immediately prior to the activation process. Alternatively, especially if the viscosity is initially very high, the resin composition could be provisionally secured to the second and/or first attachment surface in a separate step any time prior to the activation process, or could be present as separate strand or sheet of material.

According to a group of embodiments, the resin composition has a viscosity that is initially relatively high (for example, the resin composition may be pasty or rubber-like/waxy) and that is reduced as a result of the activation. FIG. 2 shows an according graph of the viscosity as a function of time. The viscosity 11 is relatively constant prior to the activation since the resin composition does not undergo any chemical transition or only a comparably slow chemical transition (for example a cross-linking) prior to the activation. After the onset 12 of the activation the viscosity firstly drops to a value at which the flowability is sufficient for the resin composition to interpenetrate structures of the first and/or second object. Thereafter, due to the initiated cross-linking, the viscosity rises again until the resin composition is sufficiently hardened to fasten the first and second objects to each other.

Generally, in embodiments, the viscosity drops by at least an order of magnitude (by at least a factor 10), and for example a plurality of orders of magnitude (by at least a factor 100) by the effect of the activation by the mechanical vibration.

The diffusion 21 of any particle or substance within the resin composition will be relatively low initially and substantially rise after the onset of the vibration, as shown in FIG. 3.

FIG. 4 shows a resin composition 3 with a resin embedding particles 71, for example vesicles filled by a substance or droplets of a substance. Since the particles are distributed within the resin, the approach according to the invention has a double effect when the substance within the particles is to be distributed in the resin:
Firstly, because the substance is present in particles distributed within the resin, which particles will dissolve/disintegrate by the effect of the vibration, the necessary length of the diffusion paths for the substance to be approximately equally distributed within the composition will be lower than if the substance was present at a surface of the resin only.
Secondly, as illustrated in FIG. 3, the diffusion itself will, due to the approach described in this text, be initially higher.

Examples for substances contained in the particles comprise a substance that activates the resin/resin composition itself and/or comprise a substance that impinges on the first and/or second attachment surface, as described hereinbefore.

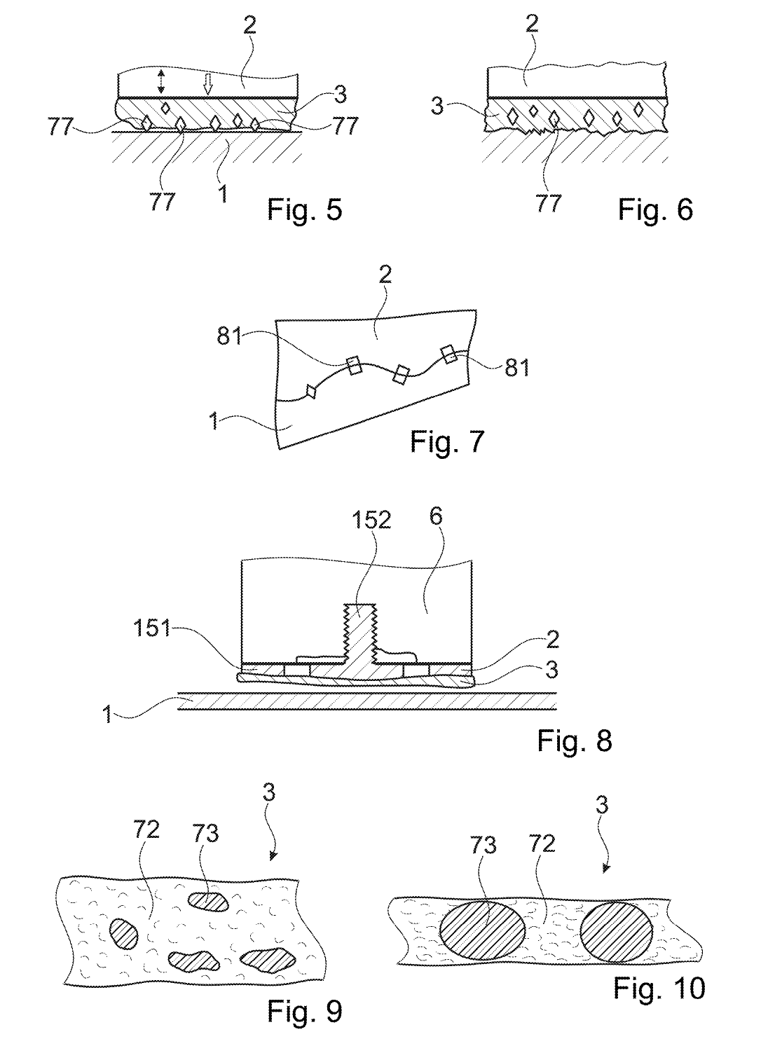

An embodiment that uses the effect of a viscosity behavior as illustrated in FIG. 2 is depicted in FIGS. 5 and 6. The resin composition comprises, in addition to the resin, abrasive particles 77 dispensed in the resin, which resin is pre-polymerized to be in a solid/waxy state. At least some of the abrasive particles form part of the surface and come into contact with the first and/or second attachment surface at the beginning of the process. When the mechanical vibration starts impinging, the still relatively solid (high viscosity) resin composition will transmit vibration, and the abrasive particles will be held in the resin matrix and by the vibration impinge on the first/second attachment surface. Thereby, an initial phase of the vibration application becomes a preparatory step (FIG. 5).

After the resin becomes sufficiently flowable, the particles will be pressed into the interior of the composition and will remain dispensed therein. The resin composition is bonded to the then roughened surface.

FIG. 7 very schematically illustrates a possible application of embodiments of the invention. A first object 1 and a second object 2 are to be bonded to each other by an adhesive connection, wherein the first and second objects are both relatively large. In a manufacturing process, the hardening of the adhesive between the objects until the bond is sufficiently strong for further manufacturing steps may cause a significant delay. The approach according to embodiments of the invention is therefore to use the fastening method described herein at a plurality of discrete spots 81 to activate the resin at these spots. Thereby, the bond is caused to be sufficiently stable in a rapid process. The resin portions between the discrete spots 81 may harden slowly thereafter while the assembly of the first and second objects is subject to further processing steps.

FIG. 8 shows an arrangement immediately prior to the activation step. The second object 2 is a fastener having an anchoring plate 151 and a fastening element 152, here being a threaded bar, secured thereto. In the embodiment of FIG. 8, the sonotrode comprises a receiving structure cooperating with the fastening element to mechanically couple the sonotrode and the second object with each other.

The first object 1 may be of any nature. In FIG. 8, it is illustrated to be a metal sheet.

The resin composition 3 is present as a coating of the second object, in FIG. 8 of the anchoring plate thereof. If the resin composition has a comparably high viscosity, for example so that it is waxy, at room temperature, it may be essentially inactive, so that the second object may even be stored with the resin composition 3 pre-applied.

FIG. 9 depicts an example of a resin composition 3 with activatable particles 73 dispersed in the resin 72, which particles are thermoplastic. When the vibration energy impinges on the composition, the thermoplastic particles will tend to absorb mechanical vibration energy and thereby induce a heating of the surrounding resin to activate the resin. Also, the thermoplastic material may have a further function, for example by contributing to the mechanical properties of the resin composition after the activation process, for example by adding a certain ductility.

FIG. 10 shows a variant of the resin composition of FIG. 9 in which variant the thermoplastic particles 73 have a size corresponding to the final thickness of the resin composition layer. Thereby, the thermoplastic particles 73 have a double function:
During the step of pressing the second object and the first object against each other, they serve as distance defining spacers.
They absorb mechanical vibration energy thereby activating the surrounding resin by heat. In contrast to the embodiment, mechanical vibration is coupled directly from the second/first object into the thermoplastic particles 73, whereby the concept is independent of the vibration transmitting properties of the resin 72.

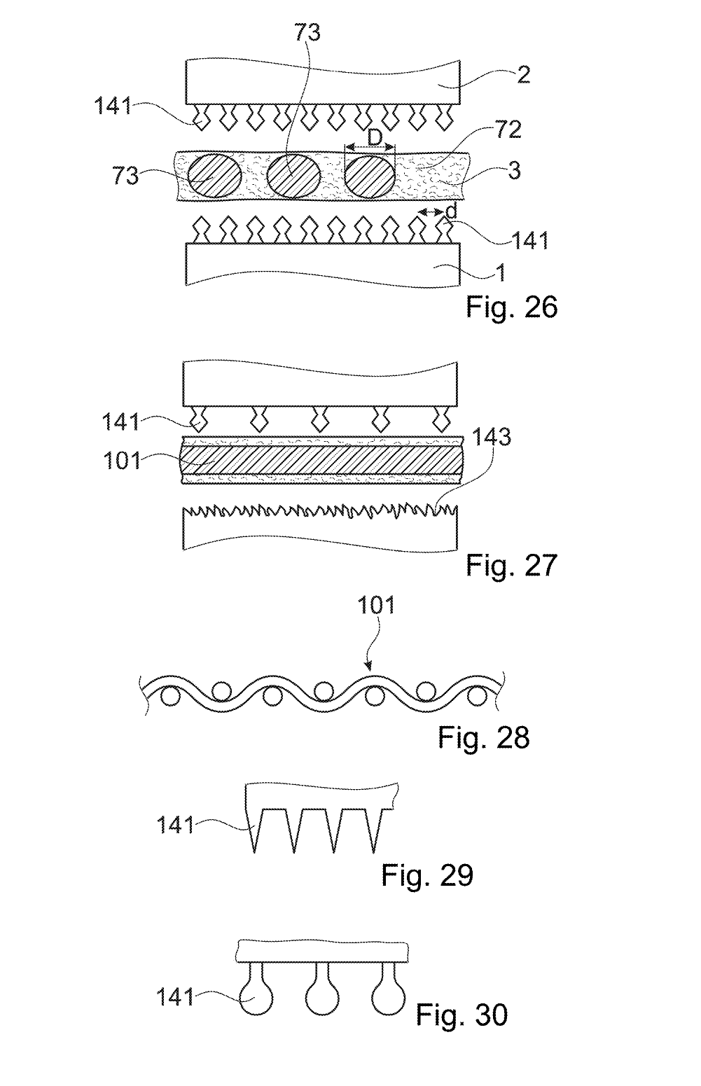

A further possible function, depending on the structure of the first and/or second object is a contribution to the anchoring as explained hereinafter referring to FIG. 26.

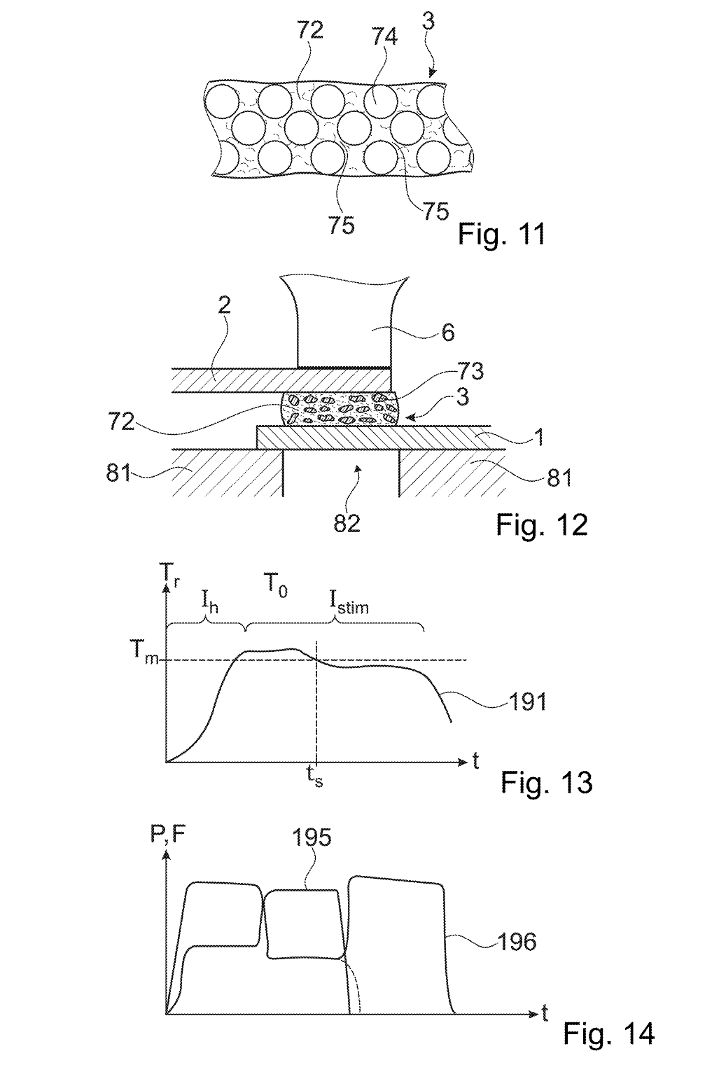

FIG. 11 shows an example of a resin composition 3 comprising particles 74, for example of glass or ceramic, that form, in the resin environment, a self-stabilizing particle network at least when composition 3 is compressed between the first and second objects. Thereby, when mechanical vibration is coupled into the resin composition, friction in the regions 75 between the particles generates heat, whereby the resin is activated.

Particle materials that are particularly suited for heat transmission/heat conduction comprise diamond, graphite, carbon(mono), aluminum nitride, boron nitride.

FIG. 12 is a further example of an arrangement of a first object 1, a second object 2, and a resin composition portion 3 therebetween. In the embodiment of FIG. 12, both, the first object 1 and the second object 2 are each illustrated to be a metal sheet, the sheets being arranged relative to one another so that they overlap at least in a region where the resin composition is between them.

The arrangement of FIG. 12 illustrates two measures for heat equalization, which two measures can be realized independent of each other.
The first object (the distal object in the set-up illustrated) is mounted on a non-vibrating support 81, which support immediately distally of the attachment spot/attachment location (the place where the resin composition is between the first and second objects) is interrupted (opening 82) so that there is no direct contact between the support and the first object 1 at the attachment location. Thereby, the heat transfer away from the first object, which being a metal sheet is a good heat conductor, to the support is strongly reduced. In addition or as an alternative, the support could be of a poorly heat conducting but nevertheless heat resistant material, such as a wood-based, fiber based (e.g.non-woven,), paper/cardboard or high temperature polymer (for example Tm>200°) material.
The resin composition comprises thermoplastic and/or PCM particles 73, which are not only capable of absorbing vibration and thereby generating heat, but are also potentially capable of absorbing heat.

As discussed hereinbefore, the filler firstly brings about the effect that an overheating of the resin is prevented in that the particles absorb heat as soon as the first order phase transition temperature (the melting temperature in the discussed embodiment) is reached and as long as not all thermoplastic material has liquefied. Thereby, the temperature is stabilized. Secondly, after the energy input is switched off, the particles dissipate heat and thereby prolong the effect of the energy input. Therefore, the processing time during which the energy is coupled into the assembly can be reduced for a given curing time. Especially, the processing time may be shorter than the time it takes for the resin to sufficiently cross-link at the processing temperature (which approximately corresponds to the melting temperature).

FIG. 13 very schematically illustrates this. FIG. 13 shows the temperature 191 of the resin as a function of time, wherein at t=0 the energy input is assumed to be switched on. During an initial phase (heating interval Iₕ), the energy input causes the temperature to rise, similarly to systems with no thermoplastic filler. As soon as the melting temperature Tₘ has been reached, the heat absorption by the thermoplastic particles increases so that the heat input does not cause a temperature rise to further than about the melting temperature (the temperature of the resin may be slightly above the melting temperature due to temperature gradients). When the energy input stops at a certain time (tₛ), the temperature will fall only slightly to below the melting temperature but will thereafter be stabilized by heat from the thermoplastic particles, which dissipate heat due to the crystallization process. The interval Iₛₜᵢₘ, during which the cross-linking is stimulated/accelerated by the resin being around the optimal crystallization temperature is thus considerably longer than the interval after the heating interval during which the energy impinges. This reduces the processing time, i.e. the time during which the assembly has to be treated actively.

FIG. 14 shows a possible process control by depicting the energy input (vibration power P) 195 and the pressing force F 196 as a function of time. This process is independent of the resin composition, i.e. may be an option for all resin compositions taught in this text.

The mechanical vibration input during a first stage is relatively small, with a small vibration amplitude, whereby a thixotropy and wetting effect is achieved, i.e. the first stage has the purpose of supporting the wetting process for securing an intimate contact between the resin composition and the objects to be joined. In this first stage, the energy input is sufficiently low to keep chemical reactions (especially cross-linking) at a minimum. This may especially be important for highly reactive systems, for example two-component systems intermixed in the liquid state.

Thereafter, in a second stage, the amplitude is higher, whereby the cross-linking process is accelerated. Then, the vibration is switched off.

The force in the first stage is relatively high to support the wetting process. Then, while the vibration amplitude is high, the force is for example reduced, especially to enable a vibration relative to one another of the objects to be joined, whereby the coupling of vibration into the resin is enabled.

In an optional third stage (pressure holding stage), the force may be maintained or even, as in the illustrated embodiment, raised, to compensate for a shrinking during the cross-linking phase.

Hereinafter, configurations are described that work both, as configurations for carrying out the method according to the present invention and as configurations for carrying out a method of fastening a second object to a first object with a conventional resin or other resin composition.

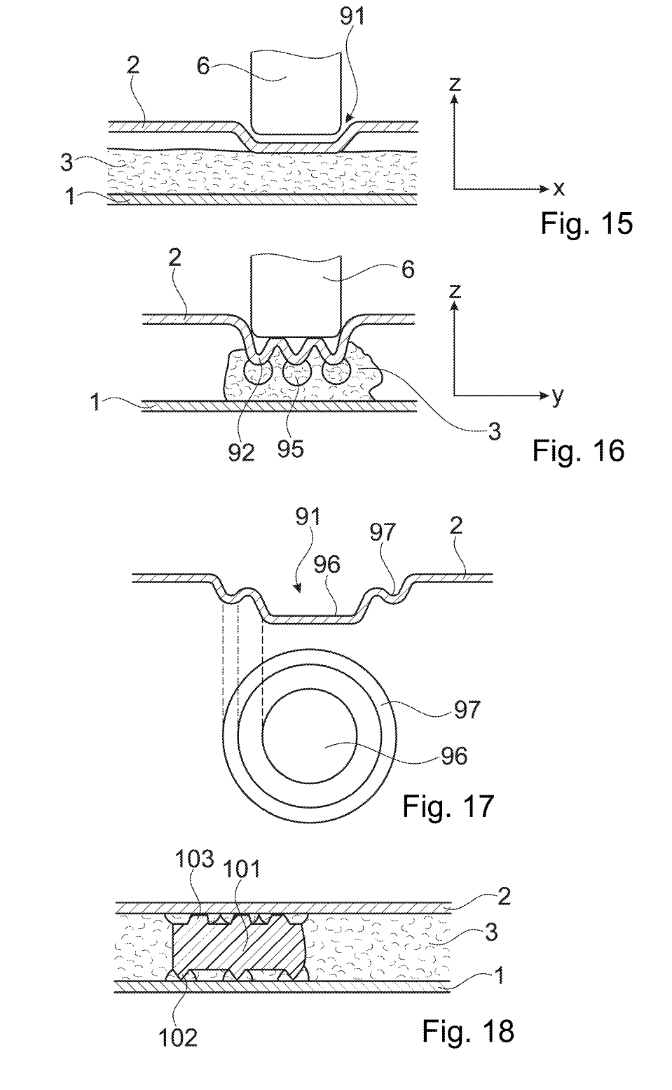

FIG. 15 depicts an arrangement of a first object 1, a second object 2 and a resin composition portion 3 therebetween. The second object 2, like, in FIG. 15, also the first object 1, is a relatively thin sheet-like object, for example a metal sheet. Both, the first and second objects are assumed to have relatively large in-plane (x-y)-extension, with the resin portion being applied extensively on the surface of at least one of the objects or, for example by a corresponding robot, an extended adhesive bead. The surface of the resin may be too large for the mechanical vibration to be applied extensively over the whole area covered by the adhesive, and the hardening may take place at discrete spots only. The remaining portions of the adhesive may harden thereafter at a much slower rate and/or induced by heating.

A possible challenge in this may be that depending on the stiffness of the second object 2 it may be difficult to selectively couple the vibration through the second object into the desired spot without too much vibration energy being dissipated by flowing away laterally.
In embodiments, the second object is of a material (for example a membrane-like thin sheet material) that is locally sufficiently pliable to selectively couple the vibration to that portion of the resin that is immediately underneath the sonotrode that couples the vibration into the second object.
In other embodiments, the second object comprises a local deformation, for example embossment that has energy directing properties.

In FIG. 15, the embossment forms a local indentation/bead 91. As shown in FIG. 16, which depicts the configuration of FIG. 15 in a section along a plane perpendicular to the section plane of FIG. 15, the indentation may optionally form a corrugation at the bottom. Thereby, a plurality of effects may be achieved:
The indentation as a whole and especially the corrugation provide pronounced structures, such as edges, that have energy directing properties. Absorption of vibration energy takes place in an intensified manner at these structures. As a consequence, the hardening process sets in around these structures, as indicated by the regions 95 in FIG. 16.
The structure influences the vibration behavior and may somewhat de-couple the regions in the indentation 91 from regions around the indentation 91.
The indentation with the structure serves as interior distance holder when the first and second objects are pressed against each other with the resin still being flowable, thereby defining the thickness of the adhesive portion after the process

FIG. 17, depicting a second object 2 in cross section (upper panel) and in a top view (lower panel), shows a variant of a structure with an indentation (that may optionally be provided with an additional structure, similar to FIG. 16), in which variant the indented region is surrounded by an embossed groove 97 that serves as joint-like structure for making vibrations primarily of the part encompassed by the groove possible.

A further possible solution to the problem of selectively coupling vibration energy into a desired spot is illustrated in FIG. 18. This solution is based on the concept of a thermoplastic particle being present in the resin composition. In contrast to the above-described embodiments, however, the particle has a defined shape and in FIG. 18 also a defined location, and thereby serves as an auxiliary element between the first object 1 and the second object 2. The auxiliary element serves as distance holder thereby defining the thickness of the resin portion 3. When mechanical vibration energy is applied for example to the second object locally at the position of the auxiliary element 101 while the second object 2 and the first object 1 are pressed against each other, the thermoplastic material of the auxiliary element absorbs vibration energy, especially due to external and/or internal friction, and thereby is locally heated. As a consequence, heat is conveyed also to surrounding resin material 3.

In embodiments, like in FIG. 18, the auxiliary element 101 has energy directors 102, 103, for example being ridges, tips or other protrusions. FIG. 18 shows first energy directors 102 at the interface to the first object 1 to be more pronounced than second energy directors 103 at the interface to the second object to compensate for an asymmetry arising from the fact that the vibrations in the depicted embodiment will be coupled into the second object and not directly into the first object.

FIG. 18 illustrates regions around the energy directors in which regions the activation of the resin material is predominating.

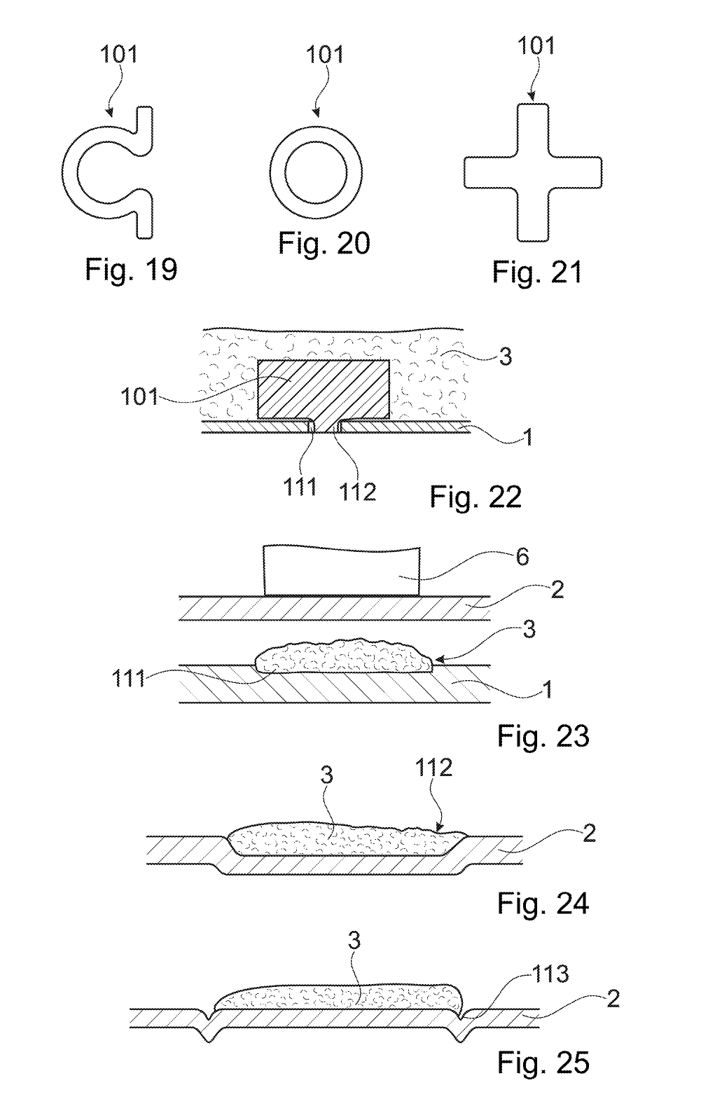

FIGS. 19-21 show top views on different auxiliary elements, thereby illustrating possible auxiliary element shapes. Generally, in embodiments it may be advantageous if the auxiliary element has a shape different form a mere disk so that the lateral surfaces are larger and thereby the interface to the resin is larger. The particles 73 dispersed in the resin in accordance with previously described embodiments may also be viewed as auxiliary elements, of essentially spherical shape.

FIG. 22, again showing a section, depicts an option of providing the auxiliary element 101 with a guiding nipple 112 cooperating with a guiding hole 111 of the first object 1 to define the exact position of the auxiliary element with respect to the first object.

In embodiments, it is advantageous if the resin composition 3 can be laterally confined to a defined region between the first and second objects at least partially. FIG. 23 shows an option to do so. The first object 1 comprises a shallow indentation 111 that defines a region for the resin composition 3. Such indentation serves as a kind of pocket confining the resin. In addition or as an alternative, the edge around the indentation may serve as flow confiner stopping the sideways flow of the resin, by capillary effects/surface tension. A similar confinement could be achieved by other discontinuity, such as a circumferential ridge or groove etc.

Similarly, as illustrated in FIG. 24, in indentation can be formed by an embossed indented structure 112 instead of a local thinning as shown in FIG. 23. Such embossed structure may optionally further comprise smaller ridges/indentations, as for example shown in FIG. 16, which ridges/indentations may be present in the first and/or in the second object and may serve as energy directors and/or distance holders.

FIG. 25 illustrates an example of a circumferential embossed groove 113 that may serve as discontinuity assisting a confinement of the resin composition 3.

FIG. 26 illustrates the principle of the first attachment surface (of the first object 1) and/or the second attachment surface (of the second object 2) comprising an attachment structure, which attachment structure is different from merely plane. In the embodiment of FIG. 26, both, the first attachment surface and the second attachment surface both comprise an attachment structure, each comprising a plurality of attachment protrusions 141. The attachment protrusions may have at least one of the following functions:
Attachments stabilization: by their structure, they, after hardening of the resin composition (including any auxiliary elements if applicable) provide additional stability by contributing to a positive-fit effect. The attachment structures illustrated in FIG. 26 are undercut with respect to longitudinal directions (directions perpendicular to the attachment surfaces), whereby after solidification of the resin composition 3 they secure the respective first/second object to the resin composition in a positive-fit manner. Also even if they are not undercut, they provide additional stability against shear forces. Similar effects may be achieved by other attachment structures, especially attachment indentations and/or roughness (see hereinafter).
Energy directing properties: the attachment protrusions or other attachment structure may have pronounced energy directing properties, for example by forming a tip (as in the embodiment of FIG. 26) and/or an edge or similar. When such pronounced feature is in physical contact with the thermoplastic particles 73 or a thermoplastic auxiliary element, it will cause strong energy absorption at the location of such contact when vibration energy is coupled into the system, thereby causing targeted heating.

In embodiments of the kind shown in FIG. 26, where the resin composition comprises relatively few relatively large dispersed thermoplastic particles 73, a possible design criterion may be that a distance d between two neighboring attachment protrusions corresponds to at most half a diameter D or to at most a diameter D of an average particle, so that every particle is in contact with at least one attachment protrusion. Fulfilling this design criterion may especially be useful if a positive-fit effect between not only the resin and the attachment structure but especially between the thermoplastic material of the particles 73 and the attachment surface is of importance and/or if the energy directing effect of the attachment structure is important.

FIG. 27 shows an embodiment that differs by the following properties from the embodiment of FIG. 26:
Instead of dispersed thermoplastic particles 73, a sheet-like auxiliary element 101 that serves as thermoplastic spacer is present. The attachment protrusions 141, the amount of resin material and the pressing force applied during the process may be adapted to each other for the attachment protrusions to penetrate into the auxiliary element 101 while locally liquefying material thereof.
The first attachment surface instead of distinct attachment protrusions comprises an attachment structure in the form of a surface roughness 143. Such surface roughness will be a macroscopic roughness that is larger than a residual (microscopic) roughness that comes about when an element is manufactured for example by injection moulding. For example, the roughness (Rₐ, arithmetic average roughness) of such roughened portion may be at least 10 μm or at least 20 μm or even at least 50 μm or at least 100 μm.

These two differences are independent of each other and do not necessarily have to be combined.

Instead of both, the first and second objects having an attachment structure, it would also be possible for just one of the objects to have such a structure.

A targeted attachment structure may for example be manufactured by a shaping process known in the art, such as laser ablation, or also a depositing process or an embossing or molding process, or in the case of surface roughness also by grinding with rough grinding means.

FIG. 28 illustrates a further embodiment of an auxiliary element 101, namely a thermoplastic mesh. Such mesh may form a ribbon. The porosity may in embodiments be about 50%, and/or it may be used as a carrier for the resin, so that placing the resin composition may comprise just placing the ribbon impregnated by the resin.

As an alternative to a mesh, also other structure impregnatable by the resin may be used, for example a cord structure or similar.

FIGS. 29 and 30 illustrate alternative shapes of attachment protrusions 141. The attachment protrusions of FIG. 29 form sharp tips so that they have good energy directing properties, whereby the energy input into the system necessary for the activation is reduced, i.e. the attachment protrusions are optimized for a penetrating into the resin composition with the dispersed particles/auxiliary element with minimal energy and time input. However, the attachment protrusions of FIG. 29 have no undercut. The embodiment of FIG. 29 is therefore suited for a quick process, for example if the required connection strength is not high or if the adhesion by the resin is particularly (sufficiently) strong.

The embodiment of FIG. 30 has attachment protrusions that do almost not have any energy directing properties but that are undercut. This embodiment may for example be suited for situations where a slow, even energy input is desired, in combination with the effect of the undercut. Other shapes with or without undercut and with or without energy directing properties are possible.

1. A method of fastening a second object to a first object, the method comprising the steps of:
providing the first object comprising a first attachment surface;
providing the second object;
placing the second object relative to the first object, with a resin composition in between the first attachment surface and the second object, wherein the resin composition comprises a resin, the resin composition having a first viscosity;
causing mechanical vibration to act on the second object or the first object or both, until the resin composition is subject to a vibration induced activation,
wherein the activation comprises at least one of reduction of the viscosity of the resin composition compared to the first viscosity, and of an activation of at least one element at least partially environed by the resin,
continuing or repeating the step causing mechanical vibration to act until the resin has at least partially cross-linked and the viscosity of the resin is increased at least locally compared to the first viscosity.
whereby the resin composition secures the second object to the first object.

2. The method according to claim 1, wherein the at least one element is a thermoplastic and/or elastomeric element, and wherein the mechanical vibration causes vibration energy to be absorbed by the element, whereby the element transfers heat to surrounding resin material.

3. The method according to claim 1, wherein the at least one element comprises a substance capable of undergoing a first-order phase transition at a temperature above room temperature, and wherein the vibration induced activation comprises causing at least portions of the material to undergo the first-order phase transition.

4. The method according to claim 3, wherein the material capable of undergoing the first-order phase transition is a thermoplastic material.

5. The method according to claim 3, wherein the material capable of undergoing the first-order phase transition is a phase change material.

6. The method according claim 1, wherein the resin composition comprises a plurality of the elements being the particles.

7. The method according to claim 6, wherein the particles have an at least approximately spherical geometry.

8. The method according to claim 6, wherein an average diameter of the particles is between 10 μm and 100 μm.

9. The method according to claim 6, wherein the particles have an elastic modulus that differs from the elastic modulus of the resin after cross linking by at most a factor 2.

10. The method according to claim 6, wherein at least the surface of the particles is capable of reacting chemically with the resin.

11. The method according to claim 6, wherein the particles comprise a polyamide polymer.

12. The method according to claim 1, wherein the at least one element at least partially environed by the resin has thermoplastic properties.

13. The method according to claim 1, wherein the at least one element at least partially environed by the resin comprises an auxiliary element, and wherein in the step of placing the second object and/or the step of causing mechanical vibration to act comprises pressing the first and second objects against each other and using the auxiliary element as a distance holder in the step of pressing.

14. The method according to claim 13, wherein the auxiliary element has thermoplastic properties and forms at least one energy directing structure.

15. The method according to claim 1, wherein the second object has a second attachment surface, wherein in the step of placing, the resin composition is between the first and second attachment surfaces, and wherein the first attachment surface or the second attachment surface or both has/have an attachment structure with at least one of attachment protrusions, attachment indentations, a macroscopic surface roughness.

16. The method according to claim 15, wherein the attachment protrusions and/or attachment indentations are undercut.

17. The method according to claim 1, wherein the at least one element at least partially environed by the resin comprises a plurality of particles dispersed in the resin.

18. The method according to claim 1, wherein the resin prior to the step of causing mechanical vibration to act is pre-polymerized.

19. The method according to claim 1, wherein the resin, at least for some time while the mechanical vibration is caused to act, is thixotropic.

20. The method according to claim 1, wherein the resin composition comprises an additive that reduces the viscosity due to the shear rate, or due to a low glass transition and/or liquefaction temperature.

21. The method according to claim 1, wherein the activation comprises a reduction of the viscosity of the resin compared to the first viscosity, and wherein the resin composition further comprises abrasive particles.

22. The method according to claim 1, wherein the resin comprises particles as the elements, the particles containing an activation component, and wherein pressing and causing mechanical vibration to act causes the activation component to be dissolved in the resin.

23. The method according to claim 22, wherein the activation component is capable of activating at least one further substance contained in the resin composition, for example the resin.

24. The method according to claim 23, wherein the activation component comprises at least one of a hardener, an initiator substance, a gas forming substance.

25. The method according to claim 22, wherein the activation component comprises a substance capable of impinging on the first attachment surface and/or a second attachment surface of the second object.

26. The method according to claim 25, wherein the activation component comprises at least one of a solvent, a primer, an etchant.

27. The method according to claim 1, comprising pressing the second object and the first object against each other while the mechanical vibration is caused to act.

28. The method according to claim 1, wherein the resin composition comprises particles capable of forming a self-stabilizing particle network.

29. The method according to claim 1, wherein a vibration power of the mechanical vibration is caused to be modulated, wherein in an initial phase the vibration power is lower than in a subsequent phase.

30. A resin composition for serving as an adhesive between a first and a second object, the resin composition comprising a resin and being activatable by mechanical vibration energy, and the resin composition further comprising at least one of;
abrasive particles dispersed in the resin, wherein the resin is equipped for its viscosity being reduced upon activation by mechanical vibration energy;
particles containing an activation substance, wherein the substance is capable of being dissolved in surrounding resin composition material upon mechanical vibration acting on the resin composition;
thermoplastic particles dispersed in the resin;
particles capable of forming a self-supporting network dispersed in the resin;
an additive causing the resin composition to be thixotropic.
